(19) United States
(12) Patent Application Publication
(10) Pub. No.: US 2025/0292634 A1
(43) Pub. Date: Sep. 18, 2025

(54) INFORMATION PROCESSING APPARATUS

(71) Applicant: TOYOTA JIDOSHA KABUSHIKI KAISHA, Toyota-shi (JP)

(72) Inventors: Tomiyasu ISHIKAWA, Okazaki-shi (JP); Tadashi MATSUI, Kasugai-shi (JP); Takumi KOZAWA, Nagoya-shi (JP); Yuto MOTOYAMA, Nagoya-shi (JP); Tsuyoshi OKADA, Nagoya-shi (JP); Yoshiaki MASUYA, Inazawa-shi (JP)

(73) Assignee: TOYOTA JIDOSHA KABUSHIKI KAISHA, Toyota-shi (JP)

(21) Appl. No.: 19/063,289

(22) Filed: Feb. 26, 2025

(30) Foreign Application Priority Data
Mar. 13, 2024 (JP) 2024-039425

(51) Int. Cl. G07C 5/08

(52) U.S. Cl. CPC G07C 5/0816

(57) ABSTRACT

In an information processing apparatus including a controller, the controller acquires birth information and usage history information for a vehicle, and presents the birth information and the usage history information to a user.

### CROSS-REFERENCE TO RELATED APPLICATION

This application claims priority to Japanese Patent Application No. 2024-039425 filed on Mar. 13, 2024, the entire contents of which are incorporated herein by reference.

### TECHNICAL FIELD

The present disclosure relates to an information processing apparatus.

### BACKGROUND

Acquiring, from among information on the progress status of multiple vehicles before delivery stored in a progress management DB, information on the progress status of a specific vehicle corresponding to identification information and providing the acquired information to the user terminal from which the identification information has been transmitted are disclosed. For example, see Patent Literature (PTL) 1.

### CITATION LIST

### Patent Literature

PTL 1: JP 2002-297954 A

### SUMMARY

The information provided to the user terminal is only the progress status of the specific vehicle before delivery, and the information presented is limited. Thus, there is room for improvement with respect to technology for providing information pertaining to vehicles.

It would be helpful to improve technology for providing information pertaining to vehicles.

An information processing apparatus according to an embodiment of the present disclosure is an information processing apparatus including a controller configured to:
acquire birth information and usage history information for a vehicle; and
present the birth information and the usage history information to a user.

According to an embodiment of the present disclosure, technology for providing information pertaining to vehicles is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of an information processing apparatus;

FIG. 3 is a block diagram illustrating a schematic configuration of a terminal apparatus; and

FIG. 4 is a flowchart illustrating operations of the information processing apparatus.

### DETAILED DESCRIPTION

Hereinafter, an embodiment of the present disclosure will be described.

### Outline of Embodiment

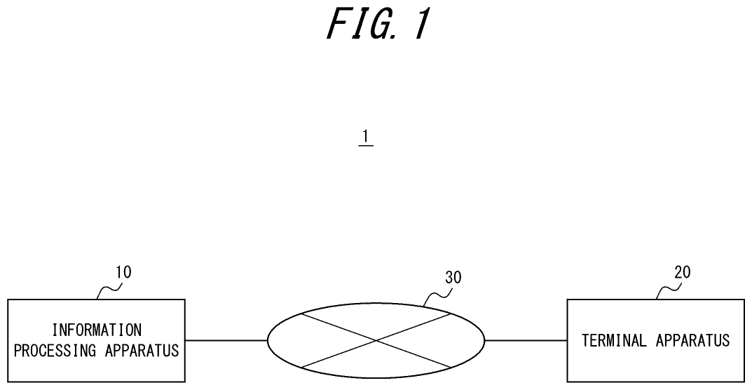

An outline and a configuration of a system 1 according to the present embodiment will be described with reference to FIG. 1.

The system 1 according to the present embodiment includes an information processing apparatus 10 and a terminal apparatus 20. The information processing apparatus 10 and the terminal apparatus 20 are communicably connected to a network 30 including, for example, a mobile communication network, the Internet, or the like.

The information processing apparatus 10 is a server apparatus installed in a data center, for example. The information processing apparatus 10 is, for example, a server that belongs to a cloud computing system or other computing systems. The information processing apparatus Is 10 can communicate with the terminal apparatus 20 via the network 30. Although an example is illustrated in FIG. 1 where there is only one information processing apparatus 10 equipped with the system 1, it is not limited to this. The system 1 may include two or more information processing apparatuses 10.

The terminal apparatus 20 is any apparatus used by a user. Users include customers awaiting delivery of their vehicles. For example, a general purpose electronic device such as a smartphone or tablet terminal, or a dedicated electronic device can be employed as the terminal apparatus 20. The example illustrated in FIG. 1 is an example of a single terminal apparatus 20 equipped with the system 1, but is not limited to this. The system 1 may include two or more terminal apparatuses 20.

First, an outline of the present embodiment will be described, and details thereof will be described later. The information processing apparatus 10 acquires birth information and usage history information for the vehicle. The information processing apparatus 10 also presents birth information and usage history information to the user.

Thus, according to the present embodiment, the information processing apparatus 10 acquires birth information and usage history information for the vehicle and presents these information to the user. Since birth information and usage history information pertaining to the vehicle is provided to the user in this way, the technology for providing information pertaining to the vehicle is improved in that it is useful, for example, in checking parts compatibility when repairing the vehicle and in making decisions when purchasing a vehicle.

Next, configurations of the system 1 will be described in detail.

### (Configuration of Information Processing Apparatus)

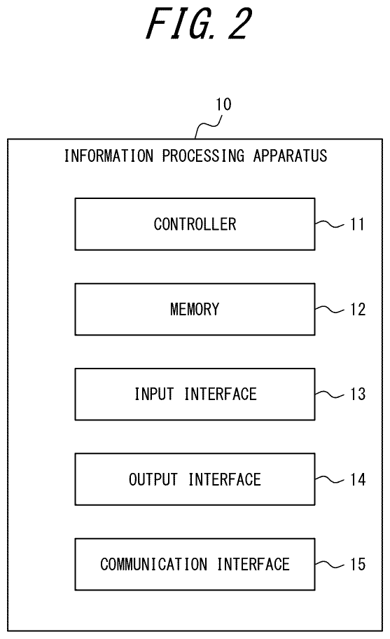

As illustrated in FIG. 2, the information processing apparatus 10 includes a controller 11, a memory 12, an input interface 13, an output interface 14, and a communication interface 15.

The controller 11 includes at least one processor, at least one dedicated circuit, or a combination thereof. The processor is a general purpose processor, such as a central processing unit (CPU) or a graphics processing unit (GPU), or a dedicated processor specialized for particular processing. The dedicated circuit is, for example, a field-programmable gate array (FPGA) or an application specific integrated circuit (ASIC). The controller 11 executes processes related to operations of the information processing apparatus 10 while controlling components of the information processing apparatus 10.

The memory 12 includes at least one semiconductor memory, at least one magnetic memory, at least one optical memory, or a combination of at least two of these. The semiconductor memory is, for example, random access memory (RAM) or read only memory (ROM). The RAM is, for example, static random access memory (SRAM) or dynamic random access memory (DRAM). The ROM is, for example, electrically erasable programmable read only memory (EEPROM). The memory 12 functions as, for example, a main memory, an auxiliary memory, or a cache memory. The memory 12 stores data to be used in the operations of the information processing apparatus 10 and data obtained by the operations of the information processing apparatus 10.

The input interface 13 includes at least one interface for input. The interface for input is, for example, a physical key, a capacitive key, a pointing device, or a touch screen integrally provided with a display. The interface for input may be, for example, an audio sensor that accepts audio input, a camera that accepts gesture input, or the like. The input interface 13 accepts an operation for inputting data to be used for the operations of the information processing apparatus 10. The input interface 13 may be connected to the information processing apparatus 10 as an external input device, instead of being included in the information processing apparatus 10. As a connection method, for example, any method such as Universal Serial Bus (USB), High-Definition Multimedia Interface (HDMI®) (HDMI is a registered trademark in Japan, other countries, or both), or Bluetooth® (Bluetooth is a registered trademark in Japan, other countries, or both) can be used.

The output interface 14 includes at least one interface for output. The interface for output is, for example, a display for outputting information in the form of a video, a speaker for outputting information in the form of audio, or the like. The display is, for example, a liquid crystal display (LCD) or an organic electro luminescent (EL) display. The output interface 14 displays and outputs data obtained by the operations of the information processing apparatus 10. The output interface 14 may be connected to the information processing apparatus 10 as an external output device, instead of being included in the information processing apparatus 10. As a connection method, any method such as USB, HDMI®, or Bluetooth® can be used.

The communication interface 15 includes at least one interface for external communication. The interface for communication may be either a wired or wireless communication interface. For wired communication, the interface for communication is, for example, a Local Area Network (LAN) interface or Universal Serial Bus (USB). For wireless communication, the interface for communication is, for example, an interface compliant with a mobile communication standard such as a Long Term Evolution (LTE), the 4th generation (4G) standard, or the 5th generation (5G) standard, or an interface compliant with a short-range wireless communication standard such as Bluetooth®. The communication interface 15 receives data to be used in the operations of the information processing apparatus 10, and transmits data obtained by the operations of the information processing apparatus 10.

The functions of the information processing apparatus 10 are realized by execution of a program according to the present embodiment by a processor corresponding to the controller 11. That is, the functions of the information processing apparatus 10 are realized by software. The program causes a computer to execute the operations of the information processing apparatus 10, thereby causing the computer to function as the information processing apparatus 10. That is, the computer executes the operations of the information processing apparatus 10 in accordance with the program to thereby function as the information processing apparatus 10.

In the present embodiment, the program can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a digital versatile disc (DVD) or a compact disc read only memory (CD-ROM) on which the program is recorded. The program may also be distributed by storing the program in a storage of an external server and transmitting the program from the external server to another computer. The program may be provided as a program product.

Some or all of the functions of the information processing apparatus 10 may be realized by a dedicated circuit corresponding to the controller 11. That is, some or all of the functions of the information processing apparatus 10 may be realized by hardware.

### (Configuration of Terminal Apparatus)

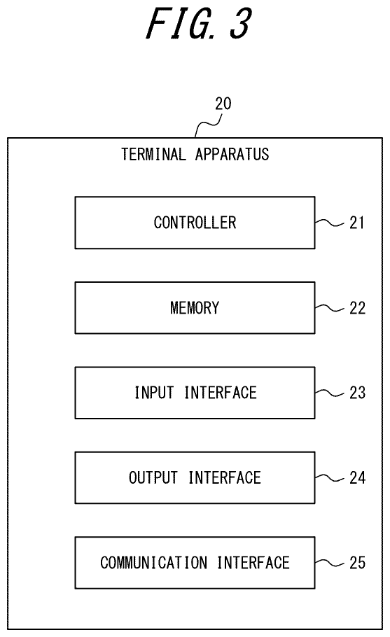

As illustrated in FIG. 3, the terminal apparatus 20 includes a controller 21, a memory 22, an input interface 23, an output interface 24, and a communication interface 25.

The controller 21 includes at least one processor, at least one dedicated circuit, or a combination thereof. The processor is a general purpose processor, such as a central processing unit (CPU) or a graphics processing unit (GPU), or a dedicated processor specialized for particular processing. The dedicated circuit is, for example, a field-programmable gate array (FPGA) or an application specific integrated circuit (ASIC). The controller 21 executes processes related to operations of the terminal apparatus 20 while controlling components of the terminal apparatus 20.

The memory 22 includes at least one semiconductor memory, at least one magnetic memory, at least one optical memory, or a combination of at least two of these. The semiconductor memory is, for example, random access memory (RAM) or read only memory (ROM). The RAM is, for example, static random access memory (SRAM) or dynamic random access memory (DRAM).

The ROM is, for example, electrically erasable programmable read only memory (EEPROM). The memory 22 functions as, for example, a main memory, an auxiliary memory, or a cache memory. The memory 22 stores data to be used for the operations of the terminal apparatus 20 and data obtained by the operations of the terminal apparatus 20.

The input interface 23 includes at least one interface for input. The interface for input is, for example, a physical key, a capacitive key, a pointing device, or a touch screen integrally provided with a display. The interface for input may be, for example, an audio sensor that accepts audio input, a camera that accepts gesture input, or the like. The input interface 23 accepts an operation for inputting data to be used for the operations of the terminal apparatus 20. The input interface 23 may be connected to the terminal apparatus 20 as an external input device, instead of being included in the terminal apparatus 20. As a connection method, for example, any method such as Universal Serial Bus (USB), High-Definition Multimedia Interface (HDMI®), or Bluetooth® can be used.

The output interface 24 includes at least one interface for output. The interface for output is, for example, a display for outputting information in the form of a video, a speaker for outputting information in the form of audio, or the like. The display is, for example, a liquid crystal display (LCD) or an organic electro luminescent (EL) display. The output interface 24 displays and outputs data obtained by the operations of the terminal apparatus 20. The output interface 24 may be connected to the terminal apparatus 20 as an external output device, instead of being included in the terminal apparatus 20. As a connection method, any method such as USB, HDMI®, or Bluetooth® can be used.

The communication interface 25 includes at least one interface for external communication. The interface for communication may be either a wired or wireless communication interface. For wired communication, the interface for communication is, for example, a Local Area Network (LAN) interface or Universal Serial Bus (USB). For wireless communication, the interface for communication is, for example, an interface compliant with a mobile communication standard such as a Long Term Evolution (LTE), the 4th generation (4G) standard, or the 5th generation (5G) standard, or an interface compliant with a short-range wireless communication standard such as Bluetooth®. The communication interface 25 receives data to be used for the operations of the terminal apparatus 20, and transmits data obtained by the operations of the terminal apparatus 20.

The functions of the terminal apparatus 20 are realized by execution of a program according to the present embodiment by a processor corresponding to the controller 21. That is, the functions of the terminal apparatus 20 are realized by software. The program causes a computer to execute the operations of the terminal apparatus 20, thereby causing the computer to function as the terminal apparatus 20. That is, the computer executes the operations of the terminal apparatus 20 in accordance with the program to thereby function as the terminal apparatus 20.

Some or all of the functions of the terminal apparatus 20 may be realized by a dedicated circuit corresponding to the controller 21. That is, some or all of the functions of the terminal apparatus 20 may be realized by hardware.

### (Operations of Information Processing Apparatus)

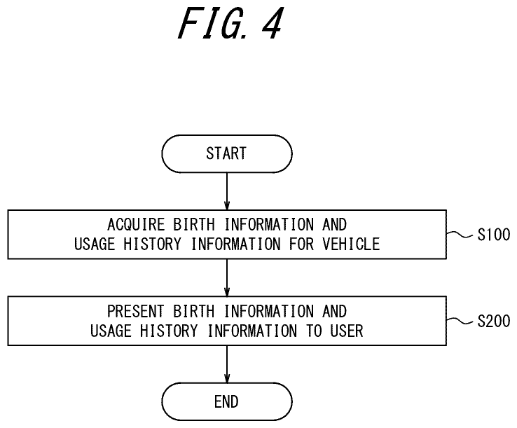

Operations of the information processing apparatus 10 according to the present embodiment will be described with reference to FIG. 4.

Step S100: The controller 11 of the information processing apparatus 10 acquires birth information and usage history information for the vehicle.

Any method can be employed to acquire the birth information and usage history information for the vehicle. For example, the controller 11 may acquire the birth information and usage history information for the vehicle from the terminal apparatus 20 via the communication interface 15 and the network 30. Alternatively, the controller 11 may acquire the birth information and usage history information for the vehicle based on input operations to the input interface 13. Any user interface can be adopted for this input operation.

Step S200: The controller 11 presents the birth information and the usage history information acquired in step S100 to the user.

Any method can be employed to present the birth information and usage history information. For example, the controller 11 may present this information by user interface via the terminal apparatus 20. Such user interface may be provided by the information processing apparatus 10 or a web server, accessed by the terminal apparatus 20 via browser software. Alternatively, an application pertaining to the system 1 may be installed on the terminal apparatus 20, and the terminal apparatus 20 may provide the user interface by communicating with the information processing apparatus 10 or application server via said application, as appropriate. In this case, the terminal apparatus 20 and the information processing apparatus 10, or the terminal apparatus 20 and the web server, may perform authentication and other processes related to the user, as appropriate.

The birth information may include a part number of a part mounted in the vehicle, the total number of parts, part manufacturing plant information, and/or manufacturing plant information for the vehicle. The inclusion of this information in the birth information allows for efficient verification of parts compatibility when vehicles are repaired.

The usage history information may include inspection history information for the vehicle. By acquiring inspection history information, the user can determine whether the vehicle has been inspected sufficiently in the past.

The usage history information may include repair history information for the vehicle. Repair history information is acquired so that the user can determine whether vehicle repairs have been adequately performed in the past. The user can also accurately determine the vehicle's accident history.

As described above, the information processing apparatus 10 according to the present embodiment acquires birth information and usage history information for the vehicle and presents these information to the user. According to this configuration, the technology for providing information pertaining to vehicles is improved in that birth information and usage history information pertaining to vehicles is provided to users, which is useful, for example, in checking parts compatibility when repairing vehicles and in making decisions when purchasing vehicles.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or a single component, step, or the like can be divided.

For example, the usage history information may include past owner information for the vehicle. Here, owner information includes information such as mileage, driver type, and intended use by the user who owned the vehicle in the past. Driver type includes safe driving type, dangerous driving type, etc. Usage includes main car, second car, etc. The fact that the usage history information includes owner information can help users make decisions when purchasing a used vehicle, etc.

1. An information processing apparatus comprising a controller configured to:
acquire birth information and usage history information for a vehicle; and
present the birth information and the usage history information to a user.

2. The information processing apparatus according to claim 1, wherein the birth information includes a part number of a part mounted in the vehicle, a total number of parts, part manufacturing plant information, and/or manufacturing plant information for the vehicle.

3. The information processing apparatus according to claim 1, wherein the usage history information includes inspection history information for the vehicle.

4. The information processing apparatus according to claim 1, wherein the usage history information includes repair history information for the vehicle.

5. The information processing apparatus according to claim 1, wherein the usage history information includes past owner information for the vehicle.
